(19) United States
(12) Patent Application Publication
(10) Pub. No.: US 2007/0157300 A1
(43) Pub. Date: Jul. 5, 2007

(54) Method and apparatus to protect server from DOS attack

(75) Inventors: Perumal Raj Sivaradjane, Kamataka (IN); Raghunandan Srinath, Kamataka (IN)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/645,670

(22) Filed: Dec. 27, 2006

(30) Foreign Application Priority Data
Dec. 12, 2006 (KR) 2006-126368
Dec. 29, 2005 (IN) 1954/CHE/2005

(51) Int. Cl. H04L 9/32

(52) U.S. Cl. 726/9

(57) ABSTRACT

A challenge-response method and apparatus to defend a system against Denial of service (DOS)/Distributed Denial of Service (DDOS) attacks, especially resource consumption attack, the method including: before committing resources to a client, throwing a challenge to the client, verifying a result generated by the client, and committing resources only if the verification is successful. When the client mounts an attack against a server by throwing multiple requests, the server will throw multiple challenges to the client and the client will get overloaded in resolving challenges thrown by the server as the server is able to control a cost of the challenge and verify responses generated for the challenge by investing minimal resources. Thus, the server's resources are free for legitimate users.

### CROSS-REFERENCE TO RELATED APPLICATIONS

This application claims the benefit of Indian Application No. 1954/CHE/2005, filed on Dec. 29, 2005 in the Indian Patent Office, and Korean Application No. 2006-126368, filed on Dec. 12, 2006 in the Korean Intellectual Property Office, the disclosure of which are incorporated herein by reference.

### BACKGROUND OF THE INVENTION

1. Field of the Invention

Aspects of the present invention relate to security and communication in networks and, in particular, to a method of designing Denial of Service (DOS) and Distributed Denial of Service (DDOS) resilient systems.

2. Description of the Related Art

A challenge-response mechanism for Denial of Service (DOS) and Distributed Denial of Service (DDOS) mitigation can be applied in the design of protocols (such as security, networking, and communication protocols) and the design of software systems and applications (such as e-commerce, m-commerce, B2B (Business to Business), B2C (Business to Consumer) applications, etc. to make them DOS resilient.

DOS attacks are attacks that aim at denying or degrading a legitimate user's access to a service or network resource, or at bringing down servers offering such services. The system under threat may be a server or servers connected to a network and a proxy server.

Generally, Anti-clogging cookies are used to mitigate DDOS attacks in an IKE (Internet Key Exchange) security protocol. First, an initiator (client) sends a cookie (Cookie-I) to a server. A responder (server) concatenates Cookie-I with the secret it owns to generate Cookie-R using a hash function. The responder does not commit its resources to the initiator at this point. Then, the responder sends Cookie-I and Cookie-R to the initiator. In the next request, the initiator sends Cookie-I and Cookie-R to the responder along with other information. The responder uses Cookie-I and again concatenates Cookie-I with the secret it owns, using the hash function If the result matches Cookie-R sent by the initiator, then the responder commits resources to the initiator.

Client puzzles employ hash algorithms to mitigate DDOS attacks. First, a server generates a random value and applies the random value to a hash function to generate a hash output (random_hash). Then, the server sends the random value with a last few bits masked and random_hash to the client. The client should find the masked bits so that the hash of the random value results in the random_hash value. The client uses brute force or linear search methods to identify the missing bits.

During DOS resistant authentication with client puzzles, the client receives random value Ns and k (number of bits to be guessed) from the server and the client tries to find X where H(C,Ns,Nc,X)=000 . . . 000(upto k bits) Y (rest of hash), in which: X is the solution to the puzzle, H represents the hash algorithm, C represents the client identity, Ns represents the server's nonce, Nc represents the client's nonce, K represents a puzzle difficulty level, 000 . . . 000 represents first k bits of hash that must be zero, and Y represents the rest of hash value, which can be anything.

Hash cash is another method to defend servers from DDOS attacks, and involves the following main operations. First, the server generates PUBLIC and PRIVATE values, such that:
PUBLIC: n=pq, where p and q are primes and n is public
PRIVATE: φ(n)=(p−1)(q−1).

Then, the server generates a challenge:
(CHAL is generated by server in interactive mode).
C<-CHAL(s,w)
   choose C in range (0,n−1)
   return (s,c,w).

Next, the client spends considerable CPU resources to find the solution to the challenge:

T<-MINT(C) compute x<-hash(s∥c)
Compute y<-xˆxˆwmodn
Return (s,c,w,y)

Finally, the server verifies the result:
V<-VALUE(T) compute x<-H(s∥c)
   Compute z<-xˆwmodφ(n)
   If xˆz═y(modn) return w
   Else return 0.

Even though the above methods are well established and widely acclaimed, they hold many demerits. One major drawback of anti-clogging cookies is that a client can still launch a DOS attack by storing Cookie-I and matching Cookie-R from the server (a light-weight session in initiator which is not costly for attacker) and sending further payloads with certificates and fake signatures. This would make the responder verify certificate chains and signatures, leading to resource intensive operations and causing denial of service to legitimate users.

A drawback of client puzzles is that the complexity of solving a puzzle increases exponentially with an increase in the number of bits to be identified. Furthermore, the cost or complexity of solving the puzzle cannot be adjusted precisely. If the client tries to solve the puzzle using brute force, the client may end up unable to find the missing bits, especially when the number of bits to be guessed is high. If a linear search is used in finding the solution (i.e., client starts from 0x00000 and goes up to 2ˆk−1 where k is the number of bits to be found) and if the server wants the client to spend considerable time in finding the solution to the puzzle, the server must reduce the challenge to some fixed range, which can be exploited to attack the server. Furthermore, solving this puzzle can be parallelized. These problems also exist with DOS resistant authentication with client puzzles.

Similarly, there are problems associated with the hash cash method. The major problem is that the verification in the server requires two exponentiation operations, which are very costly and may be used as weakness to attack the server. For example, when a challenge is received by the client and the client throws some random output to server, the server must perform two exponentiation operations to verify the result and conclude that the result is wrong.

### SUMMARY OF THE INVENTION

Aspects of the present invention provide a method and apparatus to protect servers from Denial of Service (DOS)/Distributed Denial of Service (DDOS) attacks. Aspects of the present invention also provide a computer-readable recording medium storing a program to execute the method to protect the server.

According to an aspect of the present invention, there is provided a method to protect a server from DOS (Denial of Service) attacks by avoiding an immediate commitment of the server's resources to a client that requests the server's resources, the method comprising: determining a cost required to resolve a challenge to be sent to the client; generating parameters of the challenge to be resolved according to the determined cost; generating the challenge including the parameters and sending the challenge to the client; receiving a response to the challenge from the client and verifying the validity of the response; and if the response is valid, committing the server's resources to the client.

According to another aspect of the present invention, there is provided an apparatus to protect a server from DOS attacks by avoiding an immediate commitment of the server's resources to a client that requests the server's resources, the apparatus comprising a challenge manager service performing a challenge-response operation, the challenge manager service comprising: a challenge parameter generator to determine a cost required to resolve a challenge to be sent to the client, and to generate parameters of the challenge to be resolved according to the determined cost; a challenge generator to generage the challenge including the parameters and to send the challenge to the client; and a challenge verifier to receive a response to the challenge from the client and to verify the validity of the response, wherein if the response is valid, the server commits the resources to the client.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram of a message flow in a challenge-response method where a client and a server communicate without an intermediate system according to an embodiment of the present invention;

FIG. 2 is a diagram of a message flow in a challenge-response method where a client and a server communicate with an intermediate system therebetween according to an embodiment of the present invention;

FIG. 3 is a diagram of a message flow in a challenge-response method with a minimal change of an application in a server, where a client and the server communicate without an intermediate system according to an embodiment of the present invention;

FIG. 4 is a diagram of a message flow in a challenge-response method with a minimal change of an application in a server where a client and the server communicate with intermediate system(s) therebetween according to an embodiment of the present invention;

FIG. 5 is a diagram of a message flow in a challenge-response method without any change in an application on a server and a client, where the client and the server communicate without an intermediate system according to an embodiment of the present invention;

FIG. 6 is a diagram of a message flow in a challenge-response method without any change in an application on a server and a client, where the client and the server communicate with intermediate system(s) therebetween according to an embodiment of the present invention; and

FIG. 7 is a high level block diagram illustrating challenge-response operations according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention propose a method to protect a system from a DOS/DDOS resource consumption attack, which is mounted against a system on a network when multiple requests from one or more machines are directed to the system simultaneously, resulting in an increased load on the system, blocking the system's resources (such as the CPU, memory, and disk space), thus resulting in the victim server denying service to legitimate users. The vulnerable system may be a server connected to a network or a proxy server, although not limited thereto.

It is understood that, for the purposes of this specification, any system that is vulnerable to a resource consumption attack is referred to as a server, and the system that is capable of mounting a resource consumption attack on a targeted system is referred to as client. Furthermore, the term challenge refers to a set of parameters determined by the server for which the client has to perform a modular exponentiation operation to use or solve. Also, the cost of operation is defined as effort in terms of CPU cycles and memory that must be spent by the client to resolve the challenge from the server.

In security protocols such as SSL (Secure Socket Layer), TLS (Transport Layer Security), IKE, etc., the server performs CPU intensive operations such as certificate verification and signature verification during a handshake process. A malicious attacker can misuse this feature to attack the server wherein the server's resources are virtually locked thus denying services to legitimate users. As more and more computers, devices, etc., are connected to a network with higher capabilities (processing power, memory) and increased bandwidth, resource consumption attacks based on vulnerabilities in protocols or software design are important issues to be addressed because these attacks have the potential to stop or terribly slow down business critical services indefinitely.

According to an aspect of the present invention, the server that wants to shield itself from attack does not commit resources immediately to a client. Rather, the server first checks the commitment of the client in going ahead with the protocol by throwing a challenge to the client. The client must then spend considerable resources in solving the challenge, the cost of which is controllable by the server. Once the correct results are identified or attained by the client, the client sends the results to the server. The server verifies the results sent by client, spending relatively small effort, and if the result is valid, the server then commits its resources to serving the client. The cost of the modular exponentiation operation of the client in solving the challenge is controllable by the server. The challenge is thrown by the server, which wants to defend itself from attack, or the server designates other systems to throw the challenge and validate the result.

According to an aspect of the present invention, the following parameters are pre-computed and stored in the server as part of a series of operations to generate a challenge. First, prime numbers of various sizes are generated. Then, the server calculates m such that m is a product of two or more primes. For example if p and q are primes, m=pq. Moreover, the server calculates φ(m) using Euler's Totient Function. For example, m=pq where p and q are primes, φ (m)=(p−1)(q−1), where Euler's Totient Function is denoted by the lower case Phiφ and Euler's Totient Function φ(m) returns the number of integers less than m, including 1 that are relatively prime to m. The server calculates the exponent, e1, such that e1=x*φ(m)+c, where x and c are natural numbers of arbitrary sizes (such as 128 bits and greater). Then, e2 is generated such that e2 mod(φ(m)) is not zero. Methods of generating e2 are described below. The value of e2 adds to the complexity of the challenge. The server uses this parameter to control the cost of resolving the challenge. In generating the result, r=e2 mod(φ(m)) and a margin is a small value (such as from 1 to 30). Then, d=c*r−margin is calculated and a random number a, such that gcd(a,m)=1, is generated. Finally, the server generates the result=aˆmargin mod(m). However, it is understood that according to other aspects, if c*r is greater than φ(m), then d may be calculated to have a reduced size as d=(c*r mod(φ(m)))−margin. The reduced size of d saves some bytes in the cost of performing a modular multiplication operation.

It is understood that the operations specified above may be performed in any order subject to the condition that all required parameters are available to perform a specified operation of the series of operations. Furthermore, it is understood that the operations may be performed offline (disconnected from networks), and stored in the server and/or lightweight operations may be performed when required. The values of x and c may be chosen to be as big as possible, as the bigger the values of x and c, the more difficult it is to factorize e1 and thus to find φ(m) from e1. Finally, it is understood that the value of m may be refreshed periodically for additional security.

According to another aspect of the present invention, if x is set to 1 and c=+/−margin where margin is a small value, e1 becomes e1=φ(m)+/−margin. If the values of e2 and d are fixed as e2=1 and d=0, the main operation becomes aˆ(φ(m)+/−margin) mod (m) in the client, and aˆmargin mod(m) or aˆ(−margin) mod(m) in the server, which can be calculated using an extended Eucledian algorithm. As a result, the server must refresh the value of m for almost every transaction, since the margin is a small value and φ(m) can be easily identified from e1.

The following methods are various approaches to generate e2. First, in an exponentiation method, e2=n^{exp} where n>0, exp>0 and n^{exp} mod(φ(m)) is not zero. According to a factorial method e2=num!, where num is a natural number such that e2 (mod(φ(m)) is not zero. Next, according to a hash method, a random value of arbitrary size (for example 10 bytes) is generated. Then, the server identifies the size depending on a cost of the challenge. Next, the server calculates output=hash(random)∥hash(h(1))∥hash(h(2)) . . . ∥hash(h(r)), where hash is a hashing algorithm, h(i)=hash(h(i−1)) for i ranging from 2 to r, h(1)=hash(random), and ∥indicates concatenation. The output is generated using the hash algorithm and the generated hash values are concatenated such that e2=most significant size bytes of output where e2 (mod(φ(m)) is not zero. It is understood that e2 may be calculated using one of the above-described methods offline and e2 may be stored. It is further understood that all of the pre-computations may be performed using one or more systems and/or may be performed by the server. The server may throw the challenge to the client and verify the response or a system designated by the server may throw the challenge and verify the response.

The set formed in generating the challenge along with an operation type and algorithm, if required, is sent to the client as the challenge. That is, if the challenge is generated using the exponentiation method, as described above, to generate e2, the challenge is the set (a,e1,n,exp,d,m) with operation type exponentiation. If the challenge is generated using the factorial method, as described above, to generate e2, the challenge is the set (a,e1,num,d,m) with operation type factorial. If the challenge is generated using the hash method, as described above, to generate e2, the challenge is the set (a,e1,random,size,d,m) with operation type hash and the name of hash algorithm to be used. If hash algorithm to be used is fixed in the client and the server, then the hash algorithm does not need to be exchanged.

The resolution of the challenge by the client, according to an aspect of the present invention, will now be described. If the operation type is exponentiation, the client resolves challenge by calculating the result, res, as:
res=a^{e1*(n}^{^{esp}}^{)-d)}(mod(m))

If the operation type is factorial, the client resolves the challenge by calculating the result, res, as:
res=a^{(e1*(!)-d)}(mod(m))

If the operation type is hash, the client resolves the challenge by first calculating out=hash(random)∥hash(h(1)) . . . ∥hash(h(r)), where hash is the hashing algorithm, h(i)=hash(h(i−1)) for i ranging from 2 to r, h(1)=hash(random), and ∥indicates concatenation. The client generates the output, out, using the hash algorithm and concatenates the generated hash values such that e2=the most significant size bytes of the output. Then, the client calculates the result, res, as:
res=a^{(e1*e2-d)}(mod(m))

It is understood that, according to other aspects, the sign (+ or −) in some of the equations described above in reference to the generation of the challenge and the result may be changed. For example, aˆ(−margin) mod (m) can be calculated using Extended Euclidean Algorithm. Even when the sign in some equations are changed though, the server may still perform result=aˆmargin mod(m) to calculate the result for verification.

The calculated result, res, is sent to the server. For all operation types discussed above, if the server and the client have not agreed on reducing the size of the response from the client, and if the result generated by the server, as discussed above, is equal to the value of the result, res, received from the client, the challenge is considered to be resolved successfully. Otherwise, the server concludes that the client fails to resolve the challenge.

The client, depending on an agreement with the server, may reduce the number of bytes of the response sent to the server. For example, in order to enable efficient utilization of network bandwidth, the client may send only the fingerprint of the challenge to the server, instead of sending the complete value of the result. According to an aspect of the present invention, the fingerprint may be generated by the client and the server using one of the following methods.

First, according to a hash method, the client and the server agree on a hash algorithm. The result generated by the client to the challenge is applied to the hash function to generate a hashed output. Here, the client sends the hashed output to the server. The server generates a hashed output using the server-generated result to the challenge and compares this hashed output to the hashed output received from the client. If the hashed output generated by the server matches the value sent by the client, the server concludes that the client has resolved the challenge successfully. According to an aspect of the present invention, the client and the server may agree to exchange only part of the hashed output (for example, the leading 10 bytes of the hashed output) to further reduce the number of bytes sent by the client.

According to a repeated XOR method, the client and the server first agree on a block size. If the number of bytes in the generated result to the challenge is not a multiple of the block size agreed upon, the result value is appended with a minimal number of zero bytes (0x00) at the end, so that the generated result to the challenge along with padding is a multiple of the block size. If block size is s, the number of 0x00 bytes appended at the end of result will range from 0 to (s−1).The result is divided into the agreed block size. That is, where res is the result with padding, then res=block(0)∥block(1) . . . ∥block(n), where II indicates concatenation. Then, an exclusive OR (XOR) operation is performed over the blocks to generate the output. The final output is calculated as out=block(0)\textcircled{x}block(1)\textcircled{x} . . . \textcircled{x}block(n), where\textcircled{x} indicates the XOR operation. The client sends the generated output to the server, and the server follows the repeated XOR method as explained above and generates an output using the server-generated result to the challenge. The server compares this outpout with the value received from the client. If the values match, the server concludes that the client has resolved the challenge successfully.

The underlying mathematics in checking the result generated by the client to the result generated by the server will now be described. First, when the operation type is hash, the proof for a^{e1*e2-d}(mod(m))=a^{margin}(mod(m)) is as follows:

$$\begin{matrix}{a}^{( e 1 * e 2 - d )} ( mod ( m ) ) = {a}^{( ( ( x * ϕ ( m ) + c ) * e 2 ) - d )} mod ( m ) \\ = {a}^{( ( ( x * ϕ ( m ) + c ) * ( r + y * ϕ ( m ) ) ) - d )} mod ( m ) \\ = {a}^{( ( z * ϕ ( m ) + c * r ) - d )} mod ( m ) \\ = {a}^{( ( z * ϕ ( m ) + c * r ) - ( c * r - margin ) )} mod ( m ) \\ = {a}^{( z * ϕ ( m ) + c * r - c * r + margin )} mod ( m ) \\ = {a}^{( z * ϕ ( m ) + margin )} mod ( m ) \\ = ( {a}^{( z * ϕ ( m ) )} ( mod m ) * {a}^{margin} ( mod m ) ) mod m \\ = ( {( {a}^{ϕ ( m )} ( mod m ) )}^{z} * ( {a}^{margin} ( mod m ) ) ) mod m \\ = ( {1}^{z} * ( {a}^{margin} ( mod m ) ) ) mod m \\ = {a}^{margin} ( mod m ) \\ where z is z = ( x * r + x * y * ϕ ( m ) + c * y )\end{matrix}$$

Alternatively, the −proof of
a^{(e1*e2-d)}≡a^{margin}(mod(m) is as follows:
According to Euler's theorem when gcd(a,m)=1,
a^{φ(m)}≡1(mod(m)) Equation 13:
a^{z*φ(m)}≡1^{z}(mod(m))=1(mod(m)) Equation 14:
a^{margin}≡a^{margin}(mod(m)) Equation 15:
Multiplying equations 13 and 14,
a^{z*φ(m)}*a^{margin}≡*1*a^{margin}(mod(m))
If equations 16 and 17 are valid, equation 18 is valid.
a≡b(mod(m)) Equation 16:
c≡d(mod(m)) Equation 17:

$$\begin{matrix}Equation 18 \text{:} \\ a * c ≡ b * d ( mod ( m ) ) \\ {a}^{( e 1 * e 2 - d )} = {a}^{( ( ( x * ϕ ( m ) + c ) * e 2 ) - d )} \\ = {a}^{( ( ( x * ϕ ( m ) + c ) * ( r + y * ϕ ( m ) ) ) - d )} \\ = {a}^{( ( z * ϕ ( m ) + c * r ) - d )} \\ Equation 20 \text{:} \\ = {a}^{( ( z * ϕ ( m ) + c * r ) - ( c * r - margin ) )} \\ = {a}^{( z * ϕ ( m ) + c * r - c * r + margin )} \\ = {a}^{( z * ϕ ( m ) + margin )} \\ where z is \\ z = ( x * r + x * y * ϕ ( m ) + c * y )\end{matrix}$$

If equation 15 is applied to equation 20,
a^{(z*φ(m)+margin)≡}a^{margin}(mod m)
Therefore,
a^{(e1*e2-d)}≡a^{margin}(mod(m)) 23)
Since a^{(e1*e2-d)} is congruent to a^{margin} under modulo m, reducing a^{(e1*e2-d)} and a^{margin} by modulo m would yield the same values.

Next, is an explanation of the underlying mathematics of an easy way to generate n according to the exponentiation method of generating e2, as described above, such that n^{exp} mod(φ(m)) is not zero. The proof of
n^{exp}mod(φ(m))
if n is a prime and is not a perfect divisor of φ(m) and where rem is a non-zero positive value is as follows:
n^{exp}≡rem(mod(φ(m)))
This can be proven by contraction.
n^{exp} can be written as
n^{exp}=rem+y*φ(m) Equation 27:
If rem is 0, (1) can be written as,
n^{exp}=y*φ(m) Equation 28:
n^{exp}/y=φ(m)
According to equation 28, n is a factor of φ(m), which contradicts the property that n is not perfect divisor of φ(m). So, equation 27 is invalid and there is some non-zero remainder. If n^{exp}<φ(m), then y=0 and rem is a non-zero value. n^{exp} can not be equal to φ((m) because, this contradicts the properly that n is not perfect divisor of φ(m). Thus, nˆexp mod(φ(m)) is always non-zero when n is prime, exp>=0, and n is not a perfect divisor of φ(m).

Finding φ(m) may be done either by factorizing m or by deriving the equation e1=x*φ(m)+c from e1. Both methods require factorizing big numbers, which in practice is difficult. Finding the order of a is a costly operation.

According to an aspect of the present invention, the challenge-response method explained above may be turned on when attack is anticipated and turned off in normal conditions so that the cost of the challenge-response operation may be kept as minimal as possible.

Applying the challenge-response method described above may require resolving issues related to: the overall operation considering all entities/systems involved; enabling defense functionality in legacy systems without change in existing protocol/design; the design of the protocol/system with the defense mechanism; deployment of the challenge-response with effective bandwidth utilization.

An intermediate system is a system that resides between the client and the server and performs delegated operations. There may be zero or more intermediate systems between the client and the server. Intermediate systems do not invest resources in resolving challenges and have enough information to route challenge-response related messages. For example, if a web browser is considered as the client and an HTTP server providing content is considered as the server, an HTTP proxy residing between the browser and the HTTP server is an intermediate system.

A challenge manager service resides with the server and is responsible for managing challenge-response operations. However, it is understood that according to other aspects of the present invention, the challenge manager service may reside in another system. For example, when an application in the server decides to perform a challenge-response operation, the application requests the client to contact the other system delegated to perform the challenge-response operation. The server then verifies if the client has successfully resolved the challenge with the other system.

A challenge resolver service resides in the client and resolves challenges directed thereto, ensuring that the client is not over-burdened in resolving challenges. The challenge resolver service alerts a user if the number of challenges arriving at it reaches or exceeds a threshold limit. The threshold limit may be determined by configuration parameters, resources available, and other relevant parameters. The challenge resolver service should be installed in the client in order to resolve challenges arriving thereto. For example, in an environment including a large number of mobile nodes, the challenge resolver service may be installed by a service provider or trusted authority using the OMA (Open Mobile Alliance) Device management protocol without causing any burden to the user.

A sniffer is an application that resides in the server or other system and monitors traffic, initiates challenge-response operations with the challenge manager service, and takes appropriate corrective actions when a deviation is identified.

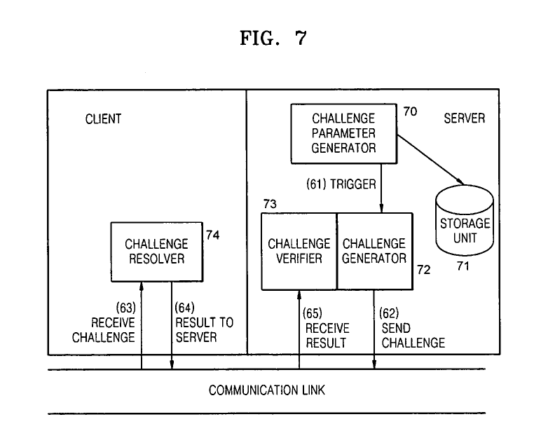

FIG. 7 is a high level block diagram illustrating challenge-response operations according to an embodiment of the present invention. Referring to FIG. 7, a server and a client are illustrated. A challenge parameter generator 70 of the server generates challenge parameters and stores the challenge parameters in a data storage unit 71. The challenge parameter generator 70 generates challenge parameters with various difficulty levels.

All operations initiated by the client to the server potentially result in the server committing considerable computing power and resources, resulting in the generation of a trigger 61 to a challenge generator 72.

If the challenge generator 72 of the server receives the trigger 61, the challenger generator 72 generates a challenge set and sends the challenge set 62 to the client through a communication link.

If the client receives the challenge 63, the client resolves the challenge using a challenge resolver 74 and sends a resolved result 64 to the communication link.

If the server receives the result 65, the server verifies the result using a challenge verifier 73. If the result is successfully verified, the server provides the client with resources and service.

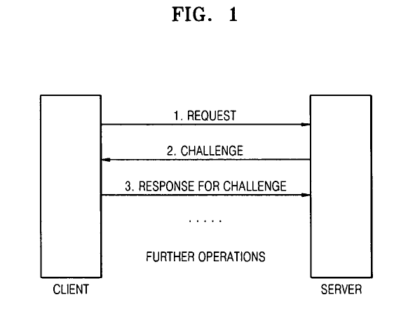

FIG. 1 is a diagram of a message flow in a challenge-response method where a client and a server communicate without an intermediate system according to an embodiment of the present invention. The challenge-response method co-exists with a protocol and/or design of the client and the server. Referring to FIG. 1, first, before committing resources for the client, the server throws a challenge (sequence 2) to the client, verifies the response (sequence 3),and commits resources to the client upon successful verification.

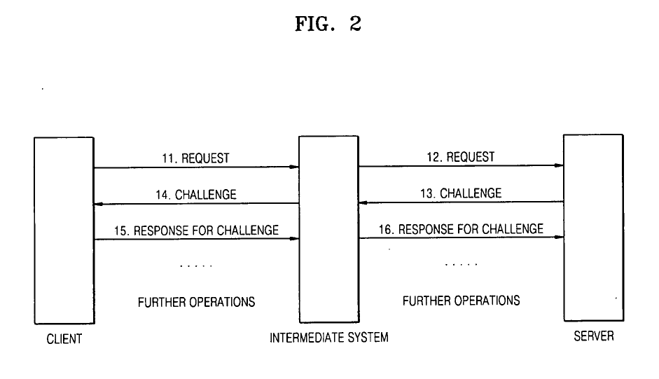

FIG. 2 is a diagram of a message flow in a challenge-response method where a client and a server communicate with an intermediate system therebetween according to an embodiment of the present invention. According to an aspect of the present invention, the client may not directly connect to the server, but through one or more intermediate systems (for example a proxy and/or a gateway). Referring to FIG. 2, when the client connects to the server through an intermediate system and requests the server's resources (sequences 11 and 12), the server throws a challenge to the client (sequence 13). The challenge received by the intermediate system (sequence 13) is routed to the client (sequence 14) and a response from the client (sequence 15) is routed to the server (sequence 16). Upon finding the response to be valid, the server commits resources to serve the client. It is understood that for messages related to the challenge-response operation, intermediate systems act as routers and do not commit resources in resolving the challenge.

The following methods relate to the employing of a challenge-response mechanism with a minimal change of an application in the server and no change of an application in the client. As described above, the server runs the challenge manager service, which throws challenges and verifies the responses. The client runs the challenge resolver service, which responds to challenges. This method enables the server to make the client perform challenges in proportion to the extent to which the client loads the server. Since the challenge resolver service in the client runs as a separate service, the challenge resolver service may be vulnerable to attack, which may be avoided by the client warning a user if the number and the complexity of arriving challenges exceeds a threshold limit. The threshold limit may be configured by the user or a trusted authority depending on the expected load on the client, resources available in the client, and application relevant parameters.

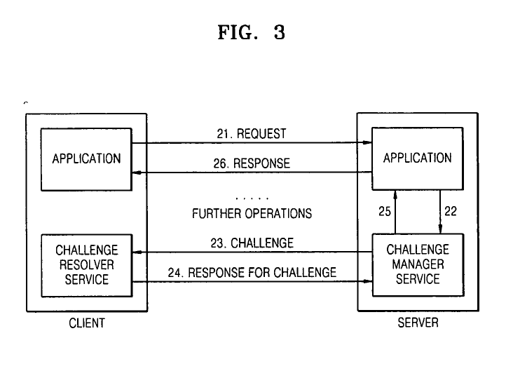

FIG. 3 is a diagram of a message flow in a challenge-response method with a minimal change of an application in a server, where a client and the server communicate without an intermediate system according to an embodiment of the present invention. Referring to FIG. 3, the server, before committing resources for the client, requests the challenge manager service to perform a challenge-response operation (sequence 22). The challenge manager service in the server throws a challenge to the client (sequence 23), receives the response (sequence 24), verifies a status of the response, and returns the status of the operation (sequence 25) to the application in the server. When the challenge-response operation is successful, the server commits resources to the client to perform further operations (sequence 26).

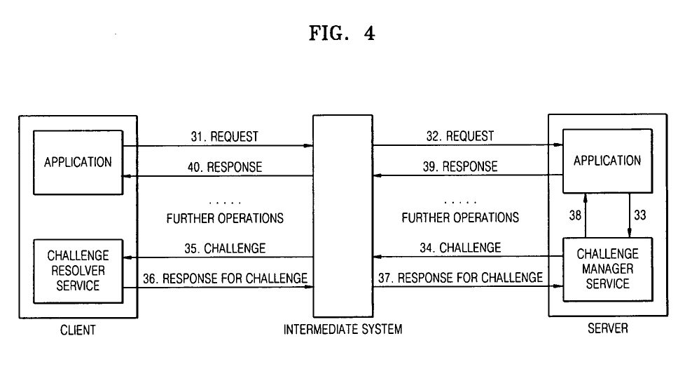

FIG. 4 is a diagram of a message flow in a challenge-response method with a minimal change of an application in a server where a client and the server communicate with intermediate system(s) therebetween according to an embodiment of the present invention. According to an aspect of the present invention, the client may not directly connect to the server, but through one or more intermediate systems (for example a proxy and/or a gateway). Referring to FIG. 4, the server, before committing resources to serve the client, requests the challenge manager service to perform a challenge-response operation (sequence 33). The challenge manager service in the server throws the challenge (sequence 34) to the client. The intermediate system, which receives the challenge, forwards the challenge to the client (sequence 35).

The challenge resolver service in the client resolves the challenge and sends the response to the intermediate system (sequence 36). The intermediate system forwards the response to the server (sequence 37). The challenge manager service in the server verifies the response from the client and passes the status of the operation to the application (sequence 38). If the challenge is resolved successfully, the server commits resources to service the client and responds to the client's request (sequence 39 and 40). In case where there are multiple intermediate systems, the multiple intermediate systems perform the operations delegated thereto by protocol and/or design. Furthermore, when a challenge is received by the intermediate system, the intermediate system acts as a channel to route the challenge and response to the appropriate entities and does not invest resources in resolving the challenge.

In some cases, applications in the server and the client cannot be changed. Accordingly, a challenge-response operation must be deployed without any change in applications in the server and the client. The sniffer, as described above, may be used to deploy the challenge-response operation without any change in applications in the server and the client. The sniffer monitors the traffic that arrives at the application in the server. Upon detecting a request, which would cause the server to perform resource intensive operations, the sniffer initiates a challenge-response operation with the challenge manager service. For example, the sniffer may initiate the challenge manager service to perform the challenge-response operation. If the response to the challenge is not correct, the sniffer may take appropriate corrective actions, such as generating system alerts to prompt administrators or configuring a firewall to drop packets originating from a specific mal-performing client.

Since the sniffer is independent of the application on the server, before the sniffer detects and completes a challenge-response operation, the application might have invested its resources to serve the client. In order to better utilize the server resources, according to an aspect of the present invention, the sniffer may reside a step ahead of the server (for example, in a firewall), where the sniffer is able to receive the packets before the packet reach the server, queue the packets for a period of time, perform a challenge-response operation, and, when a response to the challenge is successful, forward the appropriate packet in the queue to the server.

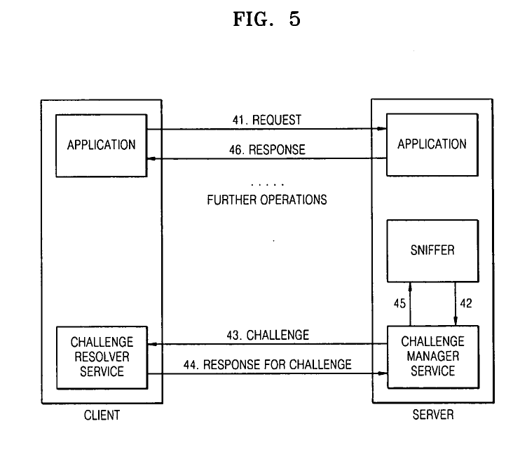

FIG. 5 is a diagram of a message flow in a challenge-response method without any change in an application on a server and a client, where the client and the server communicate without an intermediate system according to an embodiment of the present invention. Referring to FIG. 5, upon the sniffer detecting a request (sequence 41), which would cause resource intensive operations in the server, the sniffer initiates the challenge manager service in the server to perform a challenge-response operation (sequence 42). The challenge manager service throws a challenge to the client (sequence 43), receives a response from the client (sequence 44), verifies if the result is valid, and returns a status to the sniffer (sequence 45). The sniffer, upon finding results to be invalid, may take appropriate corrective actions such as alerting system administrators or blocking traffic from the client. The application in the server, after receiving the request (seq. 41), performs appropriate operations to generate a response (seq. 46).

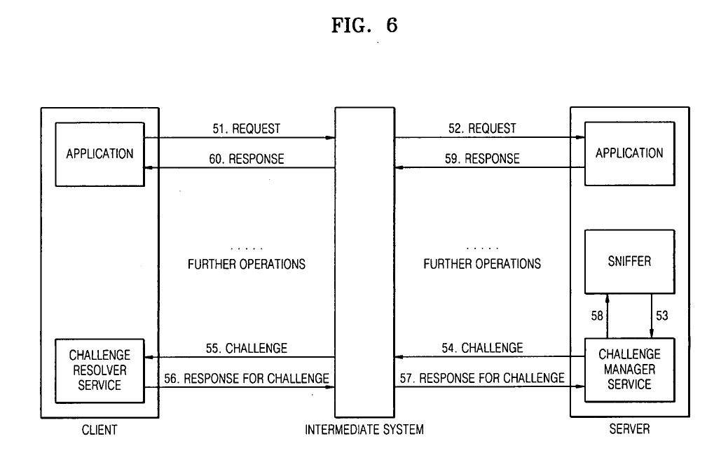

FIG. 6 is a diagram of a message flow in a challenge-response method without any change in an application on a server and a client, where the client and the server communicate with intermediate system(s) therebetween according to an embodiment of the present invention. For messages related to a challenge-response operation, an intermediate system acts as a router and does not commit resources in resolving the challenge. According to an aspect of the present invention, in some cases, the client may not directly connect to the server, but through one or more intermediate systems (for example a proxy and/or a gateway). Referring to FIG. 6, a request raised by the client reaches the server through an intermediate system (sequence 51 and 52). The sniffer, upon detecting the request, which could cause resource intensive operations in the server, initiates a challenge-response operation (sequence 53). The challenge manager service in the server throws a challenge to the client and the challenge passes through the intermediate system as shown in sequences 54 and 55. The challenge resolver service in the client resolves the challenge and sends the response to the server. The response passes through the intermediate system as shown in sequences 56 and 57.

The challenge manager service in the server verifies the response from the client and passes the status of the operation to the sniffer (sequence 58). The sniffer, upon finding the results to be invalid, may take appropriate corrective actions such as alerting system administrators or blocking traffic from the client. After receiving the request (seq. 51 and 52), the application in the server performs appropriate operations to generate a response (seq. 59 and 60). In a case where there are multiple intermediate systems, the multiple intermediate systems perform the operations delegated thereto by protocol and/or design. The intermediate systems act as a channel to route the challenge and response to the appropriate entities and do not invest resources in resolving the challenge.

Since challenge-response messages may be exchanged often before a server performs a resource intensive operation, keeping the number of bytes exchanged as minimal as possible is beneficial. The challenge parameters sent by the server contain parameters that are not refreshed often. Furthermore, there are other parameters, such as algorithms to be used for a particular operation, which are not changed often. Effective exchange of the parameters that do not change quite often will enable efficient network bandwidth utilization.

The challenge parameter set may be classified into two sub-sets, a fixed challenge parameters set and a variable challenge parameters set. Fixed challenge parameters are parameters that do not change often and have a considerable lifetime. Variable challenge parameters are parameters that change for almost every challenge-response operation.

Control parameters are the parameters that enable mapping between fixed challenge parameters and variable challenge parameters.

A system identifier is a control parameter that uniquely identifies a system that wants to defend itself from attack. The system identifier may include a Fully Qualified Domain Name (FQDN) and/or an IP address that does not change for a period of time. A system may have one or more system identifiers. A challenge identifier is a parameter that uniquely identifies fixed challenge parameters thrown by a system. The system identifier and the challenge identifier uniquely identify a fixed challenge parameter set. The challenge identifier is a unique identifier and does not repeat.

Validity parameters hold the time duration for which fixed challenge parameters are valid. Validity parameters enable the hosts to flush out out-dated fixed challenge parameters.

The following parameters are examples of fixed challenge parameters: the value m, as described above as pre-computed and stored in the server as part of a series of operations to generate a challenge; the values n and exp as well as the operation type exponentiation as described above if the exponentiation method is used; the value num along with operation type factorial as described above if the factorial method is used; the values random and size, as well as the hash algorithm and the operation type hash if the hash method is used as described above; a parameter to indicate a usage of a reducing size of a response from the client, an identifier to indicate the hash method and the hash algorithm to be used and portion of the hashed output to be exchanged (if only part of the hashed output is exchanged) if the reducing size of the response from the client is employed with the hash mechanism described above; and a parameter to indicate a usage of a reducing size of a response from the client, an identifier to indicate the XOR method, and a if the reducing size of the response from client is employed with the repeated XOR mechanism described above.

According to an aspect of the present invention, the client receives the fixed challenge parameters along with control parameters and stores the fixed challenge parameters and the control parameters for the duration of the validity period. Clients may also be configured to accept fixed challenge parameters along with control parameters only from specific systems identified by the system identifier. Thus, the client is able to ignore fixed challenge parameters arriving from unknown systems, which may not be of interest to the client. Furthermore, the fixed challenge parameters along with the control parameters may be signed in order to confirm the authenticity of the messages. Also, the fixed challenge parameters along with the control parameters, according to an aspect of the present invention, may be updated as a part of a DNS resource record so as to reach the client easily.

A challenge message exchange with variable challenge parameters and control parameters, and a challenge resolving process in the client according to an aspect of the present invention will now be described. When the server initiates a challenge-response operation, the server may send only variable portions of the challenge (with some exceptions as explained above) along with the system identifier (if required) and challenge identifier to the client. The client, upon receiving the challenge with variable parameters and required control parameters shall map to the fixed challenge parameter which are already received using the system identifier and the challenge identifier to construct complete a challenge parameter set. Once the complete challenge parameter set is identified by the client, the client performs modular exponentiation operations to solve the challenge. The resolved challenge is then sent to the server for verification.

At the time that variable challenge parameters along with control parameters are received, the client may not have appropriate mapping to the fixed-challenge parameters (for example, when the client fails to previously receive fixed challenge parameters from the server). To exchange the fixed-challenge parameters at run time, the client may send a list of challenge-identifiers that the client possesses to the server before receiving the variable challenge parameters. The server, upon detecting that the appropriate fixed-challenge parameters are not present in the client, then sends the fixed-challenge parameters along with control parameters and variable challenge parameters with required control parameters to the client. The client stores the fixed challenge parameters in the device. Once the fixed and the variable parameters are received, the client may then attempt to resolve the challenge.

To exchange the fixed-challenge parameters at run time, the server may also send a list of all fixed-challenge parameters that are supposed to be known to the client along with the specific fixed-challenge parameters that are required for the on-going challenge-response operation. The client stores all of the fixed-challenge parameters so that the client need not request for the same in later challenge-response operations.

Finally, to exchange the fixed-challenge parameters at run time, the server may keep track of fixed-challenge parameters sent to the client and the client's identity. Therefore, before performing a challenge-response operation, the server sends fixed-challenge parameters and control variables to the client if the server determines that the required fixed-challenge parameters have not previously been sent.

According to an aspect of the present invention control messages are messages sent to the client to change the validity of fixed challenge parameters. Furthermore if the server or relevant authority wants to invalidate already sent fixed-challenge parameters, the server sends a control message containing an operation type that identifies invalidation of particular fixed-challenge parameters along with control parameters, and the system identifier and challenge identifier of the fixed-challenge parameters. The client, upon receiving the control message, deletes the appropriate fixed challenge parameters and corresponding control parameters identified by the system identifier and the challenge identifier. Moreover, if the server or relevant authority wants to extend the validity period of already transmitted fixed-challenge parameters and corresponding control parameters, the server may send a control message containing an operation type that identifies extension of life-time for fixed challenge parameter set, a new time until which the fixed-challenge parameters are valid, and the system identifier and the challenge identifier of the fixed challenge parameters on which the change must be applied.

The server or relevant authority may send messages, such as fixed-challenge parameters along with control parameters or a control message, from time to time. Such asynchronous messages may be communicated to the client over a reliable and/or un-reliable transport medium. When asynchronous messages are communicated over a reliable transport medium, the server is able to keep track of the client that has received the asynchronous messages. For example, the client may run a service at a port and the server, upon knowing that the client is reachable, sends fixed-challenge parameters to the client over reliable transport mediums, such as TCP, HTTP, WAP, etc. When asynchronous messages are communicated over un-reliable transport layers, such as IP broadcast, IP multicast, UDP or any connectionless transport means, in order for the client to receive message, the server may keep sending the messages periodically or the client may use of the above-described methods to get fixed-challenge parameters at run time.

According to aspects of the present invention, the challenge-response method, as described above, that defends a system from resource consumption attacks has following advantages. First the cost of resolving the challenge can be controlled by the server. The complexity of the modular exponentiation operation in the client is directly dependent on parameters e1 and e2. Since the values of e1 and e2 are determined by the server, the server has full control over determining the cost of operation in the client.

Next, verification is a light weight operation in the server, thus saving the server's resources for critical operations. Despite cost incurred by the client in resolving the challenge, the server has only to perform aˆmargin mod(φ(m)) to verify the challenge. Since the margin is controlled by the server and is a small value, the complexity of the modular exponentiation operation performed in the server is low.

Furthermore, all of the challenge-response operations as described above can be pre-calculated. This enables the server to spend minimal resources while performing challenge-response operations at run time.

As compared to the conventional anti-clogging cookies, the anti-clogging cookies do engage the client in a resource intensive operation. According to aspects of the present invention, the cost of operation performed in the client is controllable by the server.

According to the conventional client puzzles, the complexity of resolving a challenge increases exponentially with an increase in a bit. Furthermore, even if brute force or a linear search mechanism is employed to resolve the challenge, controlling the cost of operation in the client is difficult. According to aspects of the present invention, a cost of operation in the client can be controlled by simply changing values of e1 and/or e2.

According to the conventional DOS resistant authentication with client puzzles, the complexity of resolving a challenge increases exponentially with an increase in a bit. The cost of operations can be controlled according to aspects of the present invention by simply changing values of e1 and/or e2. If the number of bits to be guessed is larger, the client may be unable to resolve the challenge. According to aspects of the present invention, results are guaranteed upon the client performing modular exponentiation to resolve the challenge.

Finally, according to the conventional hash cash method, the server performs two modular exponentiation operations in order to verify the result. According to aspects of the present invention, the server always performs aˆmargin mod (m) to verify a challenge. Since the margin is chosen by the server and may be kept low, verification is simple in the server despite cost incurred by the client in resolving the challenge.

Aspects of the present invention may be used in the design of protocols, software, and/or hardware systems to defend a system against DOS attacks. Further aspects of the present invention may be applied to protect software or hardware resources that are connected to a network from DOS attacks. Aspects of the present invention may also be applied in an environment where a system instructs another system to resolve a challenge in-order to proceed with further operations. For example, password cracking has become a common problem and the rate at which passwords are cracked may be slowed down by employing a challenge-response mechanism whereby a system (such as a server), before validating a password sent by another system (such as a client), requests that the client resolve a challenge before initiating the password verification operation. The client attempting to crack the password by throwing multiple requests would get overloaded in trying to resolve the challenges, thus slowing down the rate at which the password is cracked.

Aspects of the present invention can also be embodied as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and a computer data signal embodied in a carrier wave comprising a compression source code segment and an encryption source code segment (such as data transmission through the Internet).

According to the method and apparatus to protect a server from Denial of Service (DOS)/Distributed Denial of Service (DDOS) attacks, the apparatus that wants to defend itself from DOS/DDOS attacks (such as a server), before committing resources to a system connecting to the server (such as a client), throws a challenge to the client, verifies the result generated by the client, and commits resources only if verification is successful. When the client mounts an attack against the server by throwing multiple requests, the server will throw multiple challenges to the client and client will get overloaded in resolving the challenges thrown by server. Thus, the server's resources are free for legitimate users connecting to the server. Furthermore, the apparatus that wants to defend itself from resource consumption attacks is able to control the cost of challenge and verify responses generated for the challenge, investing minimal resources. Challenge-response operations are performed via a challenge manager service, which requires a minimal change in a given application, so that legacy systems can employ an existing protocol and/or design without change.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of protecting a system from Denial of Service (DOS) attacks by a client, the method comprising:
determining a cost required for the client to resolve a challenge;
generating the challenge comprising parameters according to the determined cost;
sending the challenge to the client;
receiving a response to the challenge from the client and verifying the validity of the response; and
committing resources of the system to the client if the response is valid.

2. The method as claimed in claim 1, wherein the system is a server connected to a network.

3. The method as claimed in claim 1, wherein the determining of the cost, the generating of the challenge, and the receiving of the response are performed by the system.

4. The method as claimed in claim 1, wherein the determining of the cost, the generating of the challenge, and the receiving of the response are performed by another system.

5. The method as claimed in claim 1, wherein the determining of the cost comprises generating the parameters according to the determined cost.

6. The method as claimed in claim 1, further comprising:
receiving a request of service from the client,
wherein one or more first parameters are generated before the receiving of the request from the client and stored in the system.

7. The method as claimed in claim 6, wherein the determining of the cost comprises:
generating one or more second parameters after the receiving of the request of service from the client.

8. The method as claimed in claim 5, wherein the generating of the parameters comprises:
calculating m that is a product of two or more prime numbers;
calculating φ(m) using Euler's Totient Function φ;
calculating e1=x*φ(m)+c where x and c are arbitrary natural numbers;
generating e2 such that e2 mod(φ(m)) is not zero;
calculating r=e2 mod(φ(m));
selecting an arbitrary integral number, margin, and calculating d=c*r−margin;
generating a random number, a, such that gcd(a,m)=1; and
generating a system result equal to aˆmargin mod(m).

9. The method as claimed in claim 8, wherein the generating of e2 comprises:
selecting n and exp where n>0 and exp>0; and
calculating e2=n^{exp} using an exponentiation method,
wherein the sending of the challenge comprises sending the parameters a, e1, n, exp, d, and m indicating that the exponentiation method is used to generate e2.

10. The method as claimed in claim 8, wherein the generating of e2 comprises:
selecting a natural number num; and
calculating e2=num! using a factorial method,
wherein the sending of the challenge comprises sending the parameters a, e1, num, d, and m indicating that the factorial method is used to generate e2.

11. The method as claimed in claim 8, wherein the generating of e2 comprises:
generating a random value, random, of arbitrary size;
determining a parameter, size, according to the cost of the challenge;
calculating output=hash(random)∥hash(h(1))∥hash(h(2)) . . . IIhash(h(r)) where h(i)=hash(h(i−1)) for i ranging from 2 to r, h(1)=hash(random), ∥ indicates concatenation, and hash represents a hash algorithm; and
generating e2 to equal a most significant size bytes of the calculated output,
wherein the sending of the challenge comprises sending the parameters a, e1, random, size, d, and m indicating that a hash method is used to generate e2 and the name of the hash algorithm.

12. The method as claimed in claim 8, wherein the generating of the parameters further comprises:
changing the values of e1 and/or e2 to control the cost for the client to resolve the challenge.

13. The method as claimed in claim 8, wherein the receiving of the response comprises:
receiving a client result, res, as the response to the challenge, wherein
the client calculates the e2, and
the client calculates the res, using a modular exponentiation operation, as res=a^{(e1*e2-d)}(mod(m)).

14. The method as claimed in claim 13, wherein the receiving of the response further comprises:
comparing the client result, res, to the system result; and
verifying that the response is valid if the client result, res, and the system result are equal.

15. The method as claimed in claim 1, wherein the sending of the challenge comprises:
sending one or more of the parameters; and
sending an operation type for which one or more of the parameters is generated.

16. The method as claimed in claim 1, further comprising:
agreeing with the client to reduce a size of the response,
wherein the receiving of the response comprises receiving a reduced size response from the client.

17. The method as claimed in claim 16, wherein the receiving of the reduced size response comprises:
receiving a fingerprint of a result generated by the client for the challenge.

18. The method as claimed in claim 17, wherein the agreeing with the client comprises:
agreeing with the client on a hash algorithm to apply to the result to get the fingerprint of the result.

19. The method as claimed in claim 17, wherein the agreeing comprises:
agreeing with the client on a block size,
wherein the fingerprint of the result is generated by:
appending the result with padding if the a size of the result is not a multiple of the block size, so that the size of the result including the padding is the multiple of the block size;
dividing the result including the padding by the block size and generating block(0), block(1), . . . , block(n), wherein the result including the padding=block(0)∥ block(1) . . . ∥block(n); and
calculating the fingerprint to be equal to block(0)\textcircled{x}block(1) . . . \textcircled{x}block(n), where \textcircled{x} is an XOR operation.

20. The method as claimed in claim 1, wherein the parameters comprise fixed challenge parameters that do not change frequently and variable challenge parameters that change frequently.

21. The method as claimed in claim 20, wherein the fixed challenge parameters are sent to the client only once.

22. The method as claimed in claim 20, wherein the sending of the challenge to the client comprises:
sending only the variable challenge parameters.

23. The method as claimed in claim 20, wherein the sending of the challenge to the client comprises:
sending the variable challenge parameters; and
sending the fixed challenge parameters if the client requests the fixed challenge parameters.

24. The method as claimed in claim 20, wherein the sending of the challenge to the client comprises:
determining if the client has the fixed challenge parameters;
sending the fixed challenge parameters and the variable challenge parameters if the client does not have the fixed challenge parameters; and
sending only the variable challenge parameters if the client has the fixed challenge parameters.

25. The method as claimed in claim 1, wherein:
the sending of the challenge to the client comprises sending the challenge to an intermediate system that sends the challenge to the client; and
the receiving of the response comprises receiving the response from the intermediate system that receives the response from the client.

26. An apparatus to protect a system from DOS attacks by a client, the apparatus comprising:
a challenge manager service to perform a challenge-response operation, the challenge manager service comprising:
a challenge parameter generator to determine a cost required for the client to resolve a challenge, and to generate parameters of the challenge according to the determined cost;
a challenge generator to generate the challenge comprising the parameters and to send the challenge to the client; and
a challenge verifier to receive a response to the challenge from the client and to verify the validity of the response,
wherein if the response is valid, the system commits resources to the client.

27. The apparatus as claimed in claim 26, wherein the system is a server connected to a network.

28. The apparatus as claimed in claim 26, wherein the challenge manager service is independent of an application that receives a request of service from the client in the system.

29. The apparatus as claimed in claim 26, wherein the apparatus is provided in the system.

30. The apparatus as claimed in claim 26, wherein the apparatus is provided in another system designated by the system to perform the challenge-response operation.

31. The apparatus as claimed in claim 26, further comprising:
a storage unit to store one or more first parameters,
wherein the challenge parameter generator generates the one or more first parameters before the system receives a request of service from the client.

32. The apparatus as claimed in claim 31, wherein the challenge parameter generator generates one or more second parameters after the system receives the request of service from the client.

33. The apparatus as claimed in claim 31, wherein the challenge parameter generator generates the parameters by:
calculating m that is a product of two or more prime numbers;
calculating φ(m) using Euler's Totient Function φ;
calculating e1=x*φ(m)+c where x and c are arbitrary natural numbers;
generating e2 such that e2 modφ(m)) is not zero;
calculating r=e2 modφ(m));
selecting an arbitrary integral number, margin, and calculating d=c*r−margin;
generating a random number, a, such that gcd(a,m)=1; and
generating a system result equal to aˆmargin mod(m).

34. The apparatus as claimed in claim 33, wherein the challenge parameter generator changes the values of e1 and/or e2 to control the cost required for the client to resolve the challenge.

35. The apparatus as claimed in claim 33, wherein the challenge verifier receives a client result, res, as the response to the challenge wherein the client calculates res by calculating the e2 and using a modular exponentiation operation to find res=a(_{e1*e2-d)}(mod(m)).

36. The apparatus as claimed in claim 35, wherein the challenge verifier compares the client result, res, to the system result and verifies that the response is valid if the client result, res, and the system result are equal.

37. The apparatus as claimed in claim 26, wherein the challenge verifier receives a fingerprint of a result generated by the client as a response to the challenge if the client and the system agree to reduce a size of the response.

38. The apparatus as claimed in claim 26, wherein the parameters comprise fixed challenge parameters that do not change frequently and variable challenge parameters that change frequently.

39. The apparatus as claimed in claim 38, wherein the challenge generator sends only the variable challenge parameters to the client.

40. The apparatus as claimed in claim 38, wherein the challenge generator sends the variable challenge parameters to the client and sends the fixed challenge parameters if the client requests the fixed challenge parameters.

41. The apparatus as claimed in claim 38, wherein the challenge generator determines if the client has the fixed challenge parameters, sends the fixed challenge parameters and the variable challenge parameters if the client does not have the fixed challenge parameters, and sends only the variable challenge parameters if the client has the fixed challenge parameters.

42. The apparatus as claimed in claim 26, wherein the client is connected to the system through an intermediate system that transfers message packets between the server and the client.

43. The apparatus as claimed in claim 26, further comprising:
a sniffer, independent of an application that receives a request of service from the client in the system, to monitor traffic to the system, and, upon detecting the request of service from the client, initiates the challenge-response operation in the challenge manager service.

44. A computer readable recording medium encoded with the method of claim 1 implemented by a computer.
